(19) United States
(12) Patent Application Publication
(10) Pub. No.: US 2026/0031672 A1
(43) Pub. Date: Jan. 29, 2026

(54) SLOTLESS STATOR WITH END CAP

(71) Applicant: FORD GLOBAL TECHNOLOGIES, LLC, Dearborn, MI (US)

(72) Inventors: Akash Changarankumarath Pradeepkumar, Westland, MI (US); Singar Rathnam, Farmington Hills, MI (US)

(21) Appl. No.: 18/783,199

(22) Filed: Jul. 24, 2024

(51) Int. Cl. H02K 3/38

(52) U.S. Cl. CPC H02K 3/38

(57) ABSTRACT

An electric machine is described, comprising a stator with a plurality of slots and an insulating ring capping an end of the stator. The insulating ring features chamfered openings aligned with the slots, a perimeter ridge, and a well region extending from the ridge to the openings. Windings are wound within and extend away from the slots without traditional slot liners.

### TECHNICAL FIELD

This disclosure relates to electric machine construction.

### BACKGROUND

Electric machines are used for propulsion in electric and hybrid electric vehicles (EVs and HEVs). These machines, typically comprising permanent magnet (PM) synchronous motors or induction motors, convert electrical energy from batteries or fuel cells into mechanical energy to drive the vehicle's wheels.

### SUMMARY

An electric machine comprises a stator defining a plurality of slots, an insulating ring capping an end of the stator, and windings wound within and extending away from the slots. The insulating ring is designed with a plurality of chamfered openings aligned with the slots, a ridge around its perimeter, and a well region extending from the ridge to the chamfered openings. The windings are positioned within the slots such that the slots lack traditional liners, allowing portions of the well region to be situated between the windings. Additionally, an insulating compound covers the well region and fills the slots, providing both electrical insulation and mechanical stability.

Another embodiment of the electric machine features a stator with slots that also lack liners and windings wound directly within these slots. This design includes means for insulating an end of the stator, thereby preventing contact between the windings and the edges of the slots, for effective insulation without traditional slot liners.

In a further embodiment, the electric machine includes a stator with slots that lack liners and a plastic end cap affixed to an end of the stator. The plastic end cap has a plurality of openings aligned with the slots that do not extend into the slots, a raised peripheral edge, and a recessed area extending from the edge to the openings. Hairpin windings are inserted into and extend from the slots in such a way that portions of the plastic end cap are situated between the stator and the hairpin windings. Additionally, varnish is applied to fill the slots and contained within the recessed area.

### BRIEF DESCRIPTION OF THE DRAWINGS

FIGS. 1A, 1B, and 2 are perspective partial assembly views of an electric machine.

FIG. 3 is a side view, in cross-section, of the electric machine of FIGS. 1A, 1B, and 2.

### DETAILED DESCRIPTION

Embodiments are described herein. It should be understood, however, that these embodiments are merely examples, and other embodiments may take various alternative forms. The figures provided are not necessarily to scale, and some features may be exaggerated or minimized to highlight particular components. Therefore, the specific structural and functional details disclosed are not to be interpreted as limiting but rather as a representative basis for teaching those skilled in the art.

Various features illustrated and described with reference to any one of the figures may be combined with features from one or more other figures to produce embodiments not explicitly illustrated or described. The combinations of features shown provide representative embodiments for typical applications. However, various combinations and modifications of these features, consistent with the teachings of this disclosure, may be desired for particular applications or implementations.

The design and operation of permanent magnet traction motors (PM motors) are at the heart of modern electric propulsion systems for automotive vehicles. These motors, which feature rotors embedded with permanent magnets and stators with wound coils, can offer a blend of efficiency, power density, and performance characteristics.

A PM motor can convert electrical energy into mechanical energy. This is primarily due to the presence of permanent magnets in the rotor, which create a constant magnetic field without the need for additional energy input. The stator, which can include multiple windings of insulated wire, is supplied with alternating current (AC) from an inverter. This AC current generates a rotating magnetic field in the stator. The interaction between the stator's rotating magnetic field and the rotor's static magnetic field produces torque, causing the rotor to turn and thus driving the vehicle's wheels.

The control of PM motors is achieved through power electronics and algorithms. The inverter, which converts the direct current (DC) from the vehicle's battery to the AC required by the motor, plays a role in this process. Modern inverters use techniques such as pulse-width modulation (PWM) to control the voltage and frequency of the AC supply, affecting the motor's performance under various driving conditions. Field-oriented control (FOC) is a widely used strategy that allows for independent control of the motor's torque and speed by aligning the stator current with the rotor's magnetic field. Another control technique is direct torque control (DTC), which directly controls the motor's torque and flux. DTC offers dynamic response and efficiency by minimizing switching losses in the inverter. These control strategies are implemented using microprocessors and sensors that monitor the motor's operating parameters, such as current, voltage, and rotor position. The integration of machine learning algorithms and predictive analytics can further enhance the motor's performance.

Noise, vibration, and harshness (NVH) characteristics are considerations in the design and operation of PM motors. While these motors are generally quieter than internal combustion engines, they can produce high-frequency noise due to electromagnetic interactions and mechanical components. Minimizing NVH requires specific design of the motor's components and mounting system, as well as the use of sound-damping materials.

The integration of PM motors within the broader vehicle systems involves several factors. Regenerative braking, for example, is a feature that allows the motor to act as a generator during slowing, converting kinetic energy back into electrical energy and recharging the battery. This not only improves energy efficiency but also extends the driving range.

The placement of PM motors within the vehicle can also affect performance and design flexibility. Some designs place the motor centrally with a transmission and drive shafts to distribute power to the wheels. However, in-wheel motor designs, where the motors are integrated directly into the wheel hubs, are gaining some popularity. In-wheel motors may eliminate the need for traditional drivetrain components, reducing mechanical losses and allowing for more flexible vehicle designs in certain circumstances. The may also, however, introduce other issues.

Traditional random winding techniques are being replaced by other methods like hairpin winding, where rectangular wires are used instead of conventional round wires. This technique can enhance the packing density of the windings, reducing resistance and improving efficiency. Hairpin winding may also improve the thermal performance of the motor by providing better heat dissipation pathways.

Thermal management maintains the performance and longevity of PM motors. High power densities and continuous operation generate heat, which if not managed can lead to degradation of the magnets and insulation materials. Cooling systems are often used, with liquid cooling being effective for high-performance applications. Liquid cooling involves circulating a coolant through channels in the motor housing, which absorbs and dissipates heat.

The choice of materials for the permanent magnets affects the performance of PM motors. Rare earth magnets, such as neodymium-iron-boron (NdFeB) and samarium-cobalt (SmCo), are commonly used due to their high magnetic strength and resistance to demagnetization. NdFeB magnets, in particular, offer some of the highest energy density among commercially available magnets, making them a choice for high-performance applications.

The rotor's geometry, including the shape and arrangement of the magnets, influences the motor's efficiency and torque characteristics. Common designs include surface-mounted magnets, where the magnets are affixed to the rotor's surface, and interior permanent magnets, where the magnets are embedded within the rotor. Surface-mounted designs are simpler to manufacture and offer high power density but may be more prone to demagnetization and mechanical stress in certain circumstances. Interior designs may provide better protection for the magnets and improved performance at high speeds, but they can be more complex to produce.

The stator often includes a laminated iron core (laminations) with slots that house the windings (e.g., copper windings). These windings are arranged for magnetic field generation. Selecting the appropriate wire gauge, insulation materials, and winding techniques is of interest. One of the components in conventional stator design is the slot liner, which protects the windings during the stator assembly magnet wire insertion process and insulates the windings from the core and prevents short circuits. The slot liner is typically made from high-temperature, high-dielectric strength materials such as Nomex or Mylar.

The installation of slot liners involves inserting the liners into the stator slots before the copper windings are placed. This can be done manually or using automated machinery, depending on the manufacturing scale and precision requirements. The slot liners should fit snugly within the slots to provide uniform insulation and support for the windings. Any gaps or misalignments can lead to electrical leakage or reduced insulation effectiveness.

Here, arrangements are proposed in which the slot liners are replaced with stator core end caps. By eliminating the slot liners, additional space within the slots is available. This space can be utilized for various purposes such as in-slot cooling, increased wire (e.g., copper) slot fill, and/or increased varnish fill, thereby potentially enhancing the overall performance and efficiency of the electric machine.

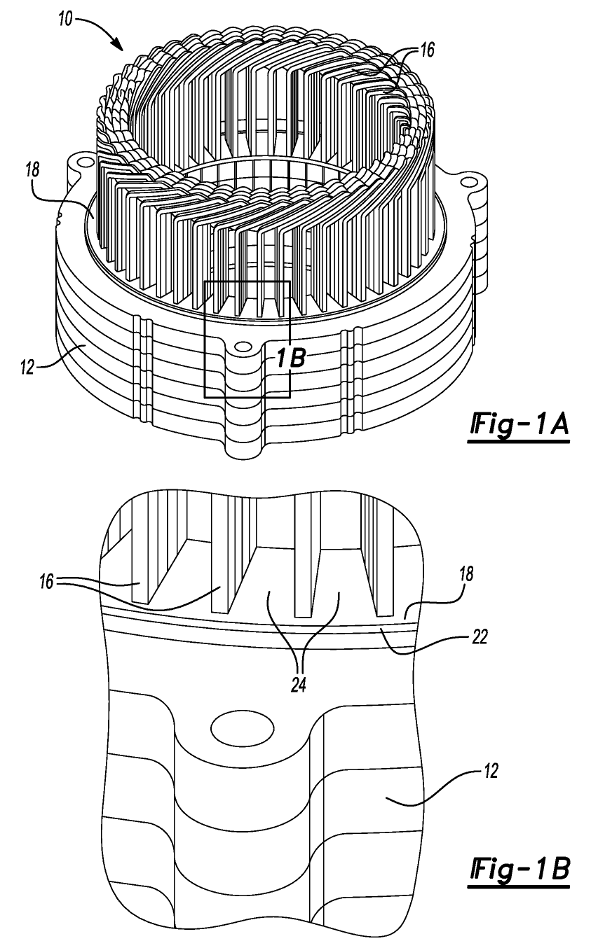

Referring to FIGS. 1A, 1B, and 2, an electric machine 10 includes, among other things, a stator 12 defining a plurality of slots 14, windings 16, and an end cap 18. The stator 12 is a core component of the electric machine 10, structured to hold the windings 16 and serve as a magnetic path that enhances the efficiency of the magnetic field generated by the windings 16. In some examples, the stator 12 is made of laminated iron or other ferromagnetic materials, which help to direct and focus the magnetic field created by the windings 16.

The stator 12 comprises a series of slots 14 designed to accommodate the windings 16. The windings 16 are positioned within the slots 14 without the use of traditional slot liners, allowing for a more compact configuration. The slots 14 lack any internal lining, which is typically used to insulate the windings 16 from the stator 12. Instead, an insulative end cap 18, or insulating ring, is placed at an end of the stator 12.

The insulative ring 18 features a plurality of chamfered openings 20 that align with the slots 14 of the stator 12. These openings facilitate the insertion of the windings 16 through the end cap 18 into the slots 14. The end cap 18 also includes a ridge 22 around its perimeter and a well region 24 extending from the ridge 22 to the chamfered openings 20. The ridge 22 serves to dam and secure the insulating compound 26 within the well region 24.

The windings 16 are arranged such that portions of the well region 24 are situated between the windings 16 and the stator 12, providing a degree of separation and additional insulation. This configuration promotes insulation of the windings 16 from the stator 12 even without traditional slot liners. Because the stator 12 lacks slot liners, the windings 16 can have a straight extension 28 (i.e., that portion of each of the windings 16 that projects straight past and away from an outer edge of the corresponding slot 14 before bending) that is reduced (e.g., less than 2.5 millimeters) relative to arrangements that use slot liners, which may be torn by windings.

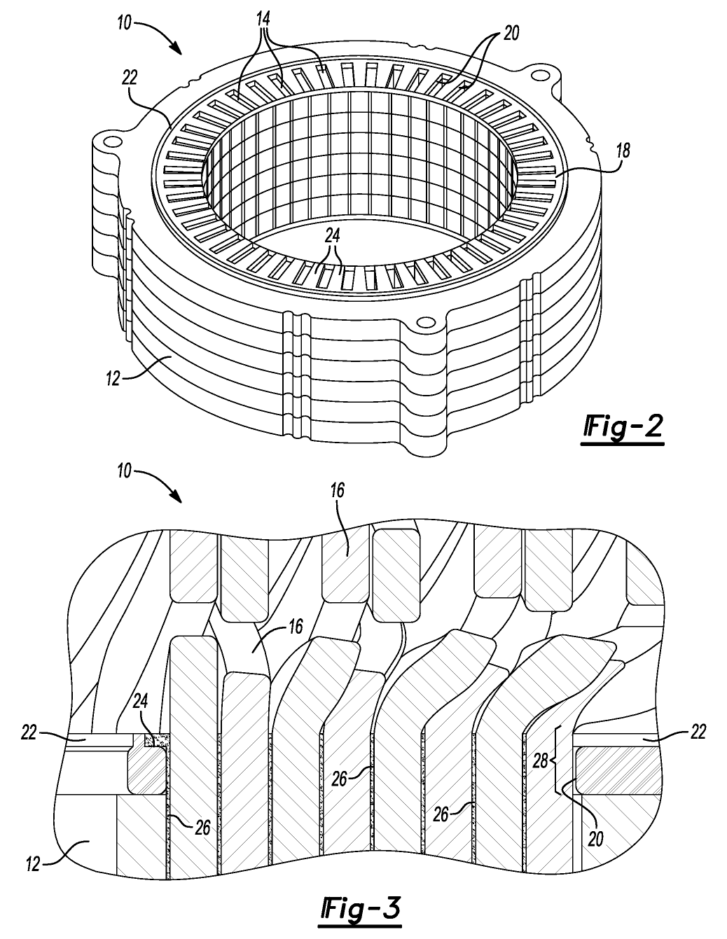

Referring to FIG. 3, once the windings 16 are positioned within the slots 14 and above the well region 24 of the insulative ring 18, the insulating compound 26 is applied. This insulating compound 26 fills the slots 14 and covers the well region 24, forming a cohesive insulating layer. The insulating compound 26, in this example, is applied such that it is flush with the top of the ridge 22. This method of filling and covering provides both electrical insulation and mechanical stability to the windings 16.

The windings 16 illustrated in the figures can be hairpin windings, random windings, formed coil windings, lap windings, wave windings, concentrated windings, distributed windings, fractional slot windings, bar windings, single layer windings, double layer windings, etc.

Nested hairpin windings are hairpin-shaped wires arranged in a specific, closely packed configuration within the slots 14 to optimize space utilization and electrical performance. Hairpin windings are pre-formed rectangular or square cross-section wires bent into a “hairpin” shape, with each hairpin having two straight legs connected by a bend. The straight sections of the hairpins are inserted into the slots 14, and their ends are welded together to form continuous windings around the stator 12. In the nested configuration, the hairpin windings are placed in a tightly packed, interleaved manner within the slots 14. The “nesting” refers to the way the hairpins are positioned relative to each other, reducing gap size and increasing the number of conductors in a given space. This arrangement can involve layering the hairpins so they fit closely together, often in multiple layers, within each of the slots slot 14. The advantages of nested hairpin windings include an increased slot fill factor, improved thermal management, enhanced mechanical stability, and reduced eddy currents and losses. By nesting the hairpins, the amount of conductive material within each of the slots 14 can be maximized, leading to a higher slot fill factor and improved electrical efficiency by reducing the resistance of the windings 16. The close packing of the windings 16 allows for better thermal conductivity and heat dissipation, as the hairpins can be in direct contact with the stator 12 and each other. The interleaved arrangement also provides mechanical support and reduces movement or vibration of the windings during operation, enhancing the durability and reliability of the electric machine 10. Additionally, the use of rectangular or square conductors in hairpin windings can reduce eddy current losses compared to traditional round wire windings, particularly when the windings are nested to minimize gaps.

The insulative ring 18 can be made of plastic, providing insulating properties while being easy to manufacture and install. Other materials, however, may be used including composite materials, ceramics, metal alloys with insulating coatings, thermosetting polymers, thermoplastics with fillers, rubber compounds, epoxy resin systems, and more. Each material offers distinct advantages such as enhanced thermal stability or mechanical strength depending on the specific requirements of the application.

The insulating compound 24 can be varnish as mentioned previously. Other materials, however, may be used including epoxy resin, silicone compounds, polyurethane resins, polyester resins, impregnating gels, thermoplastic insulating materials, ceramic insulators, fluoropolymer coatings, mica-based insulating materials, and more. These materials provide various benefits such as improved thermal management, mechanical protection, and enhanced electrical insulation, catering to different application needs and environmental conditions.

While exemplary embodiments are described above, these embodiments are not intended to encompass all possible forms covered by the claims. The language used in the specification is descriptive rather than limiting, and it is understood that various modifications can be made without departing from the spirit and scope of the disclosure.

As previously described, features of various embodiments can be combined to create further embodiments of the invention that may not be explicitly described or illustrated. Although certain embodiments may be described as offering advantages or being preferred over other embodiments or prior art implementations with respect to specific characteristics, those skilled in the art will recognize that certain features or characteristics may be adjusted to achieve the desired overall system attributes, depending on the specific application and implementation. These attributes can include, but are not limited to, strength, durability, marketability, appearance, packaging, size, serviceability, weight, manufacturability, and ease of assembly. Consequently, embodiments that may be considered less desirable in terms of one or more characteristics are not outside the scope of the disclosure and may be suitable for particular applications.

What is claimed is:

1. An electric machine comprising:
a stator defining a plurality of slots;
an insulating ring capping an end of the stator, wherein the insulating ring defines a plurality of chamfered openings in registration with the slots, a ridge around a perimeter thereof, and a well region extending from the ridge to the chamfered openings;
windings wound within and extending away from the slots such that the slots lack liners and portions of the well region are between the windings; and
an insulating compound covering the well region and filling the slots.

2. The electric machine of claim 1, wherein the insulating compound covers the well region such that a top of the ridge and the insulating compound are flush with each other.

3. The electric machine of claim 1, wherein the windings are hairpin windings.

4. The electric machine of claim 3, wherein the hairpin windings are nested hairpin windings.

5. The electric machine of claim 1, wherein the windings are wound within and extend away from the slots such that the portions of the well region are between the stator and the windings.

6. The electric machine of claim 5, wherein the windings have a straight extension less than 2.5 millimeters.

7. The electric machine of claim 1, wherein the insulating ring is plastic.

8. The electric machine of claim 1, wherein the insulating compound is varnish.

9. The electric machine of claim 1, wherein the insulating compound is epoxy resin.

10. An electric machine comprising:
a stator defining a plurality of slots;
windings wound within the slots without slot liners; and
means for insulating an end of the stator and preventing contact between the windings and edges of the slots.

11. The electric machine of claim 10, further comprising an insulating compound filling the slots and coating portions of the means.

12. The electric machine of claim 11, wherein the means is further for damming the insulating compound.

13. The electric machine of claim 10, wherein the windings are hairpin windings.

14. The electric machine of claim 10, wherein the windings have a straight extension less than 2.5 millimeters.

15. An electric machine comprising:
a stator defining a plurality of slots that lack liners;
a plastic end cap affixed to an end of the stator, wherein the plastic end cap defines a plurality of openings aligned with the slots, a raised peripheral edge, and a recessed area extending from the raised peripheral edge to the openings;
hairpin windings inserted with and extending from the slots such that portions of the plastic end cap are between the stator and nested hairpin windings; and
varnish contained within the recessed area and filling the slots.

16. The electric machine of claim 15, wherein the hairpin windings have a straight extension less than 2.5 millimeters.

17. The electric machine of claim 15, wherein the hairpin windings are nested hairpin windings.
